(19) United States
(12) Patent Application Publication
(10) Pub. No.: US 2026/0341797 A1
(43) Pub. Date: Oct. 29, 2026

(54) ELECTRODE STACK

(71) Applicant: TOYOTA JIDOSHA KABUSHIKI KAISHA, Toyota-shi (JP)

(72) Inventors: Yasuhiro SAKASHITA, Nissin-shi (JP); Yosuke SHIMURA, Nagakute-shi (JP); Suguru IKEYAMA, Toyota-shi (JP); Tomofumi HIRUKAWA, Miyoshi-shi (JP); Takahiko NAKANO, Nagoya-shi (JP); Kazuhito KATO, Toyota-shi (JP)

(73) Assignee: TOYOTA JIDOSHA KABUSHIKI KAISHA, Toyota-shi (JP)

(21) Appl. No.: 19/570,411

(22) Filed: Mar. 18, 2026

(30) Foreign Application Priority Data
Apr. 25, 2025 (JP) 2025-073727

(51) Int. Cl. H01M 10/0583; H01M 4/70; H01M 50/46

(52) U.S. Cl. CPC H01M 10/0583; H01M 4/70; H01M 50/46

(57) ABSTRACT

The electrode stack includes: a plurality of electrode sheets stacked along a first direction; and an elongated separator that extends in a zigzag manner between the electrode sheets. A plurality of notches is provided at an outer edge of at least one of the electrode sheets. The separator includes, at each of the notches, a joint portion at which surfaces facing each other are joined together.

### CROSS-REFERENCE TO RELATED APPLICATION

This application claims priority to Japanese Patent Application No. 2025-073727 filed on Apr. 25, 2025. The disclosure of the above-identified application, including the specification, drawings, and claims, is incorporated by reference herein in its entirety.

### BACKGROUND

### 1. Technical Field

The technology disclosed in the present specification relates to electrode stacks. 2. Description of Related Art

US Unexamined Patent Application Publication No. 2024/0063424 describes an electrode stack. The electrode stack includes a plurality of electrode sheets stacked on each other, and an elongated separator that extends in a zigzag manner between the electrode sheets.

### SUMMARY

In an electrode stack like the one described above, the electrode sheets each placed between the separators may shift out of position relative to the separators. In view of this, the present specification provides a technique for suppressing such misalignment of the electrode sheets with respect to the separators.

The technology disclosed in the present specification is embodied in an electrode stack. According to one aspect, an electrode stack includes: a plurality of electrode sheets stacked along a first direction; and a separator that is elongated and extends in a zigzag manner between the electrode sheets. A plurality of notches is provided at an outer edge of at least one of the electrode sheets. The separator includes, at each of the notches, a joint portion at which surfaces facing each other are joined together.

In the above electrode stack, the notches are provided at the outer edge of at least one of the electrode sheets. At each of the notches, the surfaces of the separator facing each other are joined together via the joint portion. With this configuration, the joint portions regulate the position of the outer edge of the electrode sheet, thereby suppressing misalignment of the electrode sheet relative to the separator.

According to a second aspect, in the first aspect, the electrode sheets may each have a rectangular shape defining four corners when viewed along the first direction. In this case, the notches may include two notches respectively provided at two of the four corners. With this configuration, the joint portions can regulate the positions of the two corners of the electrode sheet.

According to a third aspect, in the second aspect, the notches may include two notches respectively provided at two diagonally opposed corners of the four corners. With this configuration, the joint portions can regulate the positions of the two diagonally opposed corners of the electrode sheet.

According to a fourth aspect, in the second aspect, the notches may include four notches respectively provided at the four corners. With this configuration, the joint portions can regulate the positions of the four corners of the electrode sheet.

According to a fifth aspect, in any one of the first to fourth aspect, the entirety of the joint portion of the separator may be located within each of the notches, when viewed along the first direction. With this configuration, the size of the separator is less likely to become excessively large relative to the size of the electrode sheet, when viewed along the first direction.

According to a sixth aspect, in any one of the first to fifth aspects, the electrode sheets each may include a current collector foil and an electrode active material layer provided on one surface of the current collector foil. In this case, each of the notches may reach an outer edge of the electrode active material layer, and notches corresponding to the notches may be provided at the outer edge of the electrode active material layer. The portion in which an electrode active material layer is provided on one surface of the current collector foil has a greater rigidity than the portion where the current collector foil alone is present. With this configuration, a notch can be formed by cutting through the portion where the electrode active material layer is provided on one surface of the current collector foil. This makes it relatively easy to form the notch.

According to a seventh aspect, in any one of the first to sixth aspects, in the joint portion of the separator, the surfaces facing each other may be directly heat-welded together.

According to an eighth aspect, in any one of the first to sixth aspects, in the joint portion of the separator, the surfaces facing each other may be joined through a joining material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the external appearance of a battery 100 using an electrode stack 10 according to an embodiment;

FIG. 2 is a diagram illustrating that the electrode stack 10 is housed inside an exterior member 102;

FIG. 3 is a diagram schematically showing the configuration of the electrode stack 10 according to the embodiment;

FIG. 4A is an enlarged view of a portion IV(A) in FIG. 3;

FIG. 4B is an enlarged view of a portion IV(B) in FIG. 3.

FIG. 5 is a diagram showing notches 30a of the embodiment as viewed along the Z-direction;

FIG. 6 is a sectional view taken along line VI-VI in FIG. 5;

FIG. 7A is a diagram showing the notches 30a of a modification as viewed along the Z-direction;

FIG. 7B is a diagram showing the notches 30a of another modification as viewed along the Z-direction; and

FIG. 7C is a diagram showing the notches 30a of still another modification as viewed along the Z-direction.

### DETAILED DESCRIPTION OF EMBODIMENTS

An electrode stack 10 according to an embodiment and a battery 100 employing the electrode stack 10 will be described. The battery 100 is, for example, a lithium-ion secondary battery. The battery 100 has a rectangular, flat plate shape. In the following description, the thickness direction of the battery 100 is referred to as the Z-direction, the longitudinal direction of the battery 100 as the X-direction, and the direction orthogonal to both the Z-and X-directions as the Y-direction.

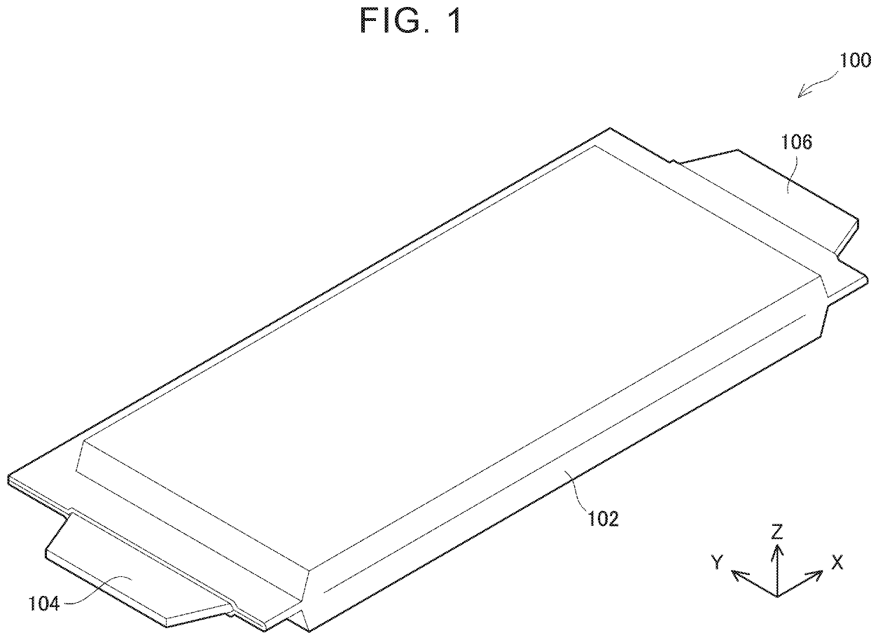

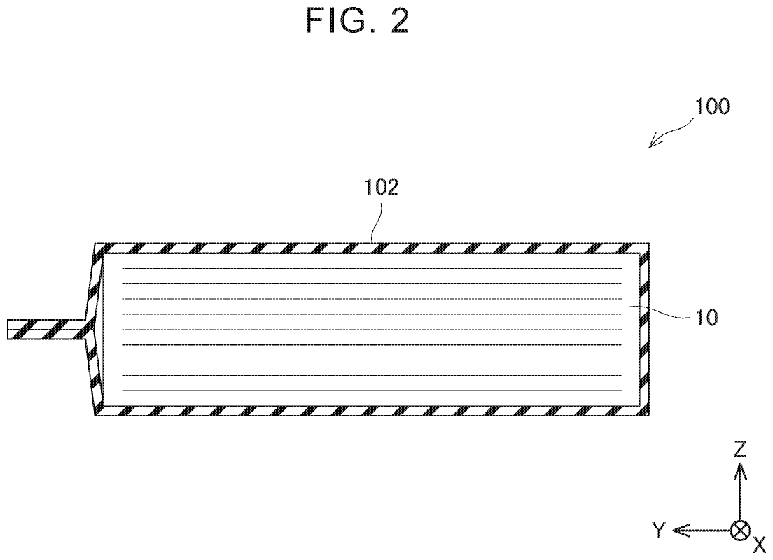

As shown in FIGS. 1 and 2, the battery 100 includes an exterior member 102.

The electrode stack 10 is sealed in the exterior member 102 together with an electrolytic solution (not shown). The exterior member 102 is formed of a thin film. For example, the exterior member 102 may be a laminate film in which resin coating films are provided on both surfaces of an aluminum foil.

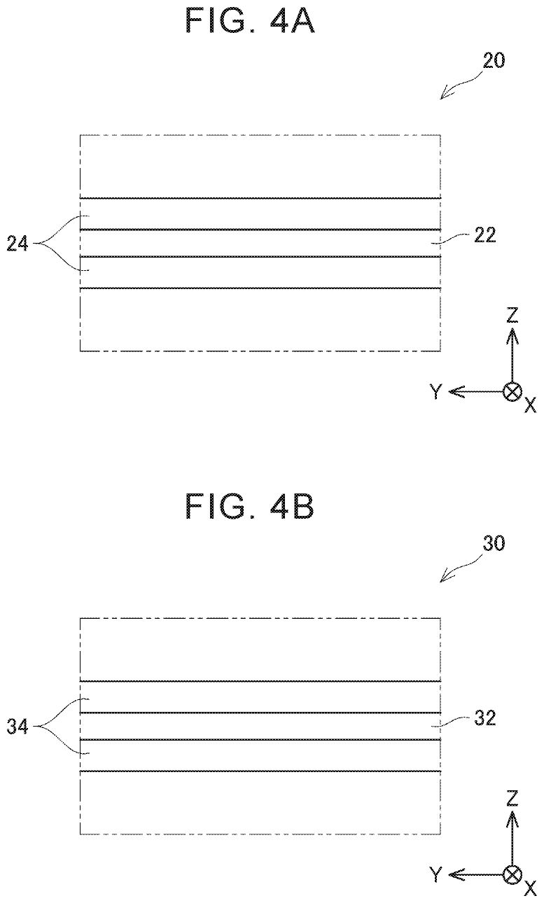

As shown in FIG. 1, the battery 100 further includes a cathode terminal 104 and an anode terminal 106. One end of the cathode terminal 104 is exposed outside the exterior member 102, and the other end of the cathode terminal 104 is connected, inside the exterior member 102, to each cathode current collector foil 22 of the electrode stack 10 (see FIG. 4A). One end of the anode terminal 106 is exposed outside the exterior member 102, and the other end of the anode terminal 106 is connected, inside the exterior member 102, to each anode current collector foil 32 of the electrode stack 10 (see FIG. 4B). The other end of the cathode terminal 104 may be connected to each cathode current collector foil 22 through a corresponding tab formed integrally with that cathode current collector foil 22, or may be connected to each cathode current collector foil 22 through a corresponding tab joined to that cathode current collector foil 22 by welding or another method. Similarly, the other end of the anode terminal 106 may be connected to each anode current collector foil 32 through a corresponding tab formed integrally with that anode current collector foil 32, or may be connected to each anode current collector foil 32 through a corresponding tab joined to that anode current collector foil 32 by welding or another method.

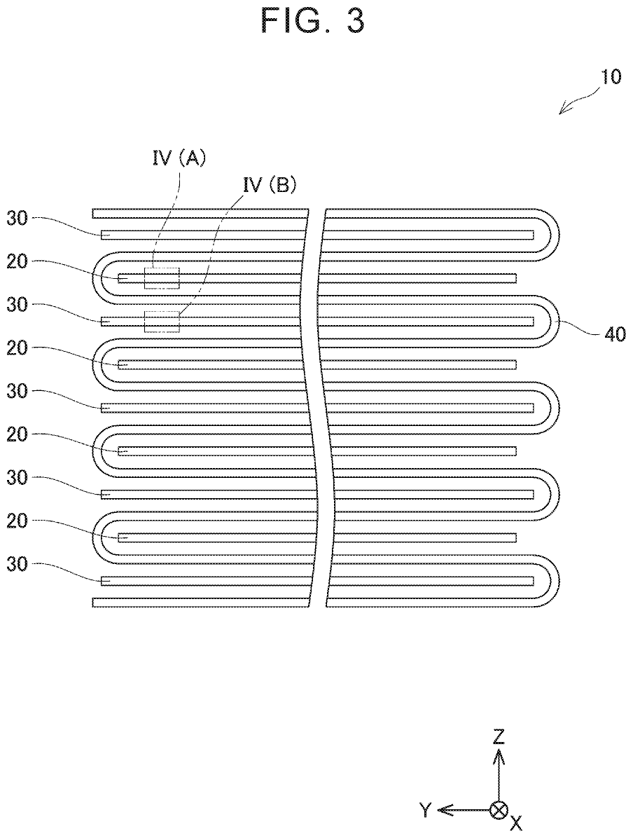

As shown in FIG. 3, the electrode stack 10 includes a plurality of electrode sheets 20, 30 and a separator 40. The electrode sheets 20, 30 are stacked along the Z-direction. Each electrode sheet 20, 30 has a rectangular shape defining four corners when viewed along the Z-direction. The electrode sheets 20, 30 include a plurality of cathode sheets 20 and a plurality of anode sheets 30. In one example, the size of each cathode sheet 20 is smaller than that of each anode sheet 30. The separator 40 is an elongated sheet. The separator 40 extends in a zigzag manner between each adjacent pair of cathode and anode sheets 20, 30. That is, the separator 40 is folded at prescribed intervals by alternating mountain folds and valley folds. The cathode sheets 20 and the anode sheets 30 are alternately stacked, with one cathode sheet 20 and one anode sheet 30 disposed between each pair of folded portions of the separator 40. The number of electrode sheets 20, 30 included in the electrode stack 10 is not particularly limited.

As shown in FIG. 4A, each cathode sheet 20 includes a cathode current collector foil 22 and two cathode active material layers 24. Each of the cathode current collector foil 22 and the cathode active material layers 24 has a rectangular shape defining four corners when viewed along the Z-direction. The cathode current collector foil 22 is, for example, an aluminum foil. The two cathode active material layers 24 are provided respectively on both surfaces of the cathode current collector foil 22 in the Z-direction. The sizes of the two cathode active material layers 24 in each cathode sheet 20 may be the same or may be different from each other. Each cathode sheet 20 may not include two cathode active material layers 24. For example, in another embodiment, each cathode sheet 20 may include one cathode active material layer 24 provided on one surface of the cathode current collector foil 22 in the Z-direction.

Each cathode active material layer 24 contains a cathode active material. Examples of cathode active materials include lithium nickel composite oxides, lithium cobalt composite oxides, and lithium manganese composite oxides. The cathode active material may be formed of a single material or of multiple materials. Each cathode active material layer 24 may further contain a binder, a conductive additive, etc.

As shown in FIG. 4B, each anode sheet 30 includes an anode current collector foil 32 and two anode active material layers 34. Each of the anode current collector foil 32 and the anode active material layers 34 has a rectangular shape defining four corners when viewed along the Z-direction. The anode current collector foil 32 is, for example, a copper foil. The two anode active material layers 34 are provided respectively on both surfaces of the anode current collector foil 32 in the Z-direction. The sizes of the two anode active material layers 34 in each anode sheet 30 may be the same or may be different from each other. Each anode sheet 30 may not include two anode active material layers 34. For example, in another embodiment, each anode sheet 30 may include one anode active material layer 34 provided on one surface of the anode current collector foil 32 in the Z-direction.

Each anode active material layer 34 contains an anode active material. Examples of anode active materials include carbon materials such as graphite, hard carbon, and soft carbon; materials that form alloys with lithium such as silicon (Si); and lithium alloys. The anode active material may be formed of a single material or of multiple materials. Each anode active material layer 34 may further contain a binder etc.

The separator 40 is configured to allow charge carriers (in this case, lithium ions) to pass therethrough. The separator 40 is formed of, for example, an insulating material. Examples of the separator 40 include porous polymer films and porous nonwoven fabrics. A porous polymer film may be formed of, for example, a polyolefin polymer such as an ethylene polymer, a propylene polymer, an ethylene/butene copolymer, an ethylene/hexene copolymer, and an ethylene/methacrylate copolymer. The porous polymer film may be a single-layer film or may be a film including two or more layers. A porous nonwoven fabric may be formed of, for example, high-melting-point glass fibers or polyethylene terephthalate fibers. The surface of the porous polymer film or porous nonwoven fabric may be coated with a ceramic material.

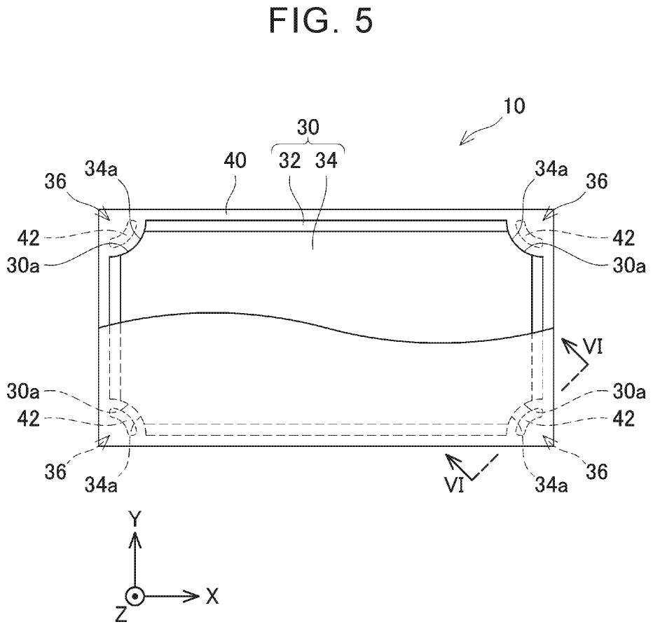

As described above, each anode sheet 30 has a rectangular shape defining four corners 36 when viewed along the Z-direction. As shown in FIG. 5, four notches 30a are provided at the outer edge of each anode sheet 30. Each of the four notches 30a is provided at a corresponding one of the four corners 36. Similarly, each cathode sheet 20 has a rectangular shape defining four corners when viewed along the Z-direction. Four notches are provided at the outer edge of each cathode sheet 20. Each of the four notches is provided at a corresponding one of the four corners. When viewed along the Z-direction, each of the four notches 30a provided in each anode sheet 30 overlaps a corresponding one of the four notches provided in each cathode sheet 20. The shape and/or size of each notch 30a provided at the outer edge of each anode sheet 30 may be the same as, or may be different from, the shape and/or size of each notch at the outer edge of each cathode sheet 20.

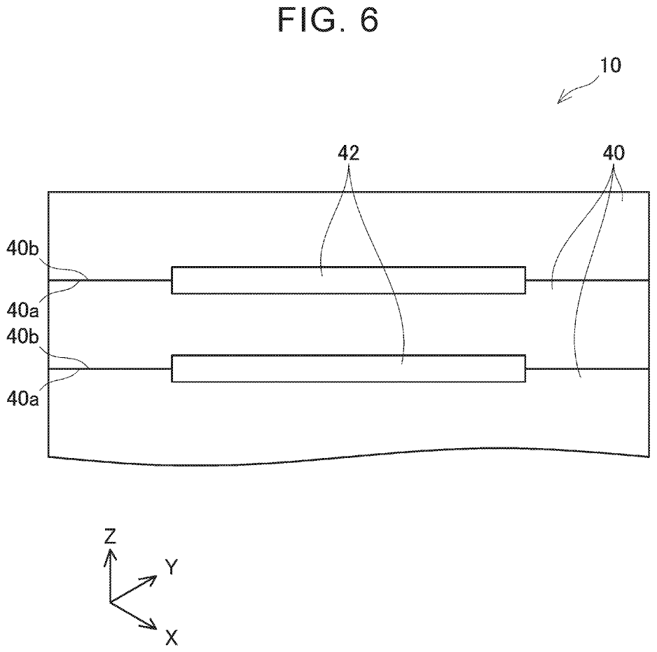

With this configuration, at each notch 30a, the separator 40 has a first surface 40a located on one side of the electrode sheets 20, 30 in the Z-direction, and a second surface 40b located on the other side of the electrode sheets 20, 30 in the Z-direction. The first surface 40a and the second surface 40b face each other. As shown in FIG. 6, at each notch 30a, the separator 40 includes a joint portion 42 where the first surface 40a and the second surface 40b are joined together. Accordingly, the joint portion 42 regulates the positions of the outer edges of the electrode sheets 20, 30, thereby suppressing misalignment of the electrode sheets 20, 30 relative to the separator 40. In particular, when a joint portion 42 is provided at each of the four corners 36 of the outer edge of each electrode sheet 20, 30, misalignment of the electrode sheets 20, 30 relative to the separator 40 can further be suppressed.

The method for joining the first surface 40a and the second surface 40b is not particularly limited. For example, in some embodiments, the joint portion 42 may be formed as a welded portion in which the two surfaces 40a, 40b are directly heat-welded together. In this case, the two surfaces 40a, 40b may be heated to a temperature higher than or equal to the melting point of the material of the separator 40. The heating temperature for the two surfaces 40a, 40b is not particularly limited, but may be 145 °C or more and 155 °C or less. As described above, in the present embodiment, each notch 30a of the anode sheet 30 overlaps a corresponding one of the notches of the cathode sheet 20, when viewed along the Z-direction. Accordingly, after all of the electrode sheets 20, 30 are placed between the folded portions of the separator 40, multiple joint portions 42 can be formed at once by heating the portions of the separator 40 that overlap the notches 30a in the Z-direction. However, the joint portions 42 may alternatively be formed separately.

In another embodiment, the joint portion 42 may be formed using a joining material such as an adhesive or an adhesive tape. The joining material may be an insulating material. Examples of joining materials include polyvinylidene fluoride (PVdF) and styrene-butadiene rubber (SBR). The joining material may be applied to either or both of the two surfaces 40a, 40b by, for example, a spraying method. After the joining material is applied to either or both of the two surfaces 40a, 40b, the separator 40 may be pressed with the two surfaces 40a, 40b in contact with each other. In this case, the separator 40 may be pressed using, for example, a brush or a roller, or may be pressed using air pressure from a blower.

In one example, as shown in FIG. 5, the entire joint portion 42 of the separator 40 is located within the notch 30a, as viewed along the Z-direction. With this configuration, the size of the separator 40 is less likely to become excessively large relative to the sizes of the electrode sheets 20, 30, when viewed along the Z-direction.

In one example, in the anode sheet 30, the size of the anode active material layer 34 is smaller than the size of the anode current collector foil 32, as shown in FIG. 5. Accordingly, the outer edge of the anode active material layer 34 is located inward of the outer edge of the anode current collector foil 32, when viewed along the Z-direction. The notches 30a provided in the anode sheet 30 extend to the outer edge of the anode active material layer 34. Accordingly, notches 34a corresponding to the notches 30a are formed at the outer edge of the anode active material layer 34. Similarly, in the cathode sheet 20, the size of the cathode active material layer 24 is smaller than the size of the cathode current collector foil 22. The notches 30a provided in the cathode sheet 20 also extend to the outer edge of the cathode active material layer 24, and notches corresponding to these notches are formed at the outer edge of the cathode active material layer 24. Accordingly, each notch 30a can be formed, for example, by cutting through the portions where the electrode active material layers 24, 34 are provided on one surface of the current collector foils 22, 32. Accordingly, compared with a case where notches are formed by cutting through only the portions where the current collector foils 22, 32 are present, the notches 30a can be formed more easily. The shape and/or size of each notch 34a formed in the anode active material layer 34 may be the same as, or may be different from, the shape and/or size of each notch formed in the cathode active material layer 24.

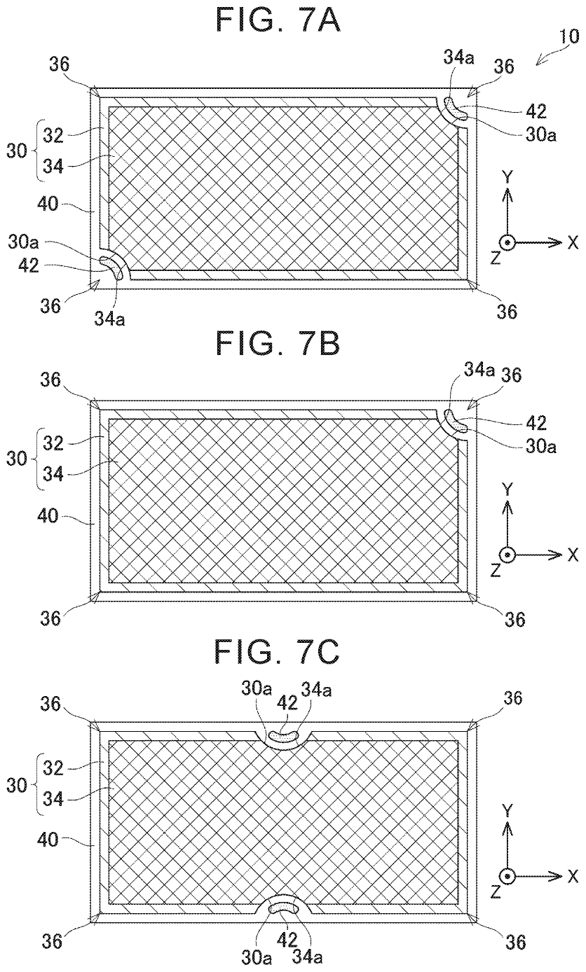

In the above embodiment, four notches 30a are provided at the outer edge of each electrode sheet 20, 30. However, it is sufficient that at least two notches is provided at the outer edge of at least one of the electrode sheets 20, 30. For example, two notches 30a may be provided at the outer edge of at least one of the electrode sheets 20, 30. In this case, as shown in FIG. 7A, the two notches 30a may be respectively provided at two adjacent ones of the four corners of at least one of the electrode sheets 20, 30. Alternatively, as shown in FIG. 7B, the two notches 30a may be respectively provided at two diagonally opposed ones of the four corners of at least one of the electrode sheets 20, 30. With this configuration, the joint portions 42 can regulate the positions of the two adjacent corners, or the two diagonally opposed corners, of at least one of the electrode sheets 20, 30.

Alternatively, for example, as shown in FIG. 7C, the two notches 30a may be respectively provided on a pair of opposing sides that define the outer edge of at least one of the electrode sheets 20, 30. With this configuration, the joint portions 42 can regulate the positions of the pair of opposing sides defining the outer edge of at least one of the electrode sheets 20, 30.

In the above embodiment, each of the notches 30a of the anode sheet 30 overlaps a corresponding one of the notches of the cathode sheet 20, when viewed along the Z-direction. However, a notch 30a provided in one anode sheet 30 may not overlap a notch 30a provided in another anode sheet 30 and/or a notch provided in the cathode sheet 20.

In the above embodiment, the outer edge of each electrode active material layer 24, 34 have a rectangular shape defining four corners, when viewed along the Z-direction. However, the shape of the outer edge of each electrode active material layer 24, 34, when viewed along the Z-direction, is not particularly limited.

Although some specific examples have been described in detail above, these examples are merely illustrative and do not limit the scope of the claims. The technology described in the claims includes various modifications and alterations of the examples illustrated above. The technical elements described in the present specification or in the drawings exhibit technical utility either individually or in combination.

What is claimed is:

1. An electrode stack comprising:
a plurality of electrode sheets stacked along a first direction; and
an separator that is elongated and extends in a zigzag manner between the electrode sheets, wherein:
a plurality of notches is provided at an outer edge of at least one of the electrode sheets; and
the separator includes, at each of the notches, a joint portion at which surfaces facing each other are joined together.

2. The electrode stack according to claim 1, wherein:
the electrode sheets each have a rectangular shape defining four corners when viewed along the first direction; and
the notches include two notches respectively provided at two of the four corners.

3. The electrode stack according to claim 2, wherein the notches include two notches respectively provided at two diagonally opposed corners of the four corners.

4. The electrode stack according to claim 2, wherein the notches include four notches respectively provided at the four corners.

5. The electrode stack according to claim 1, wherein an entirety of the joint portion of the separator is located within each of the notches, when viewed along the first direction.

6. The electrode stack according to claim 1, wherein:
the electrode sheets each include a current collector foil and an electrode active material layer provided on one surface of the current collector foil; and
each of the notches reaches an outer edge of the electrode active material layer, and notches corresponding to the notches are provided at the outer edge of the electrode active material layer.

7. The electrode stack according to claim 1, wherein, in the joint portion of the separator, the surfaces facing each other are directly heat-welded together.

8. The electrode stack according to claim 1, wherein, in the joint portion of the separator, the surfaces facing each other are joined through a joining material.
